(19) United States
(12) Patent Application Publication
(10) Pub. No.: US 2014/0292855 A1
(43) Pub. Date: Oct. 2, 2014

(54) INKJET PRINTING APPARATUS AND PRINTING METHOD

(71) Applicant: Yuan Chang, Newtown Square, PA (US)

(72) Inventor: Yuan Chang, Newtown Square, PA (US)

(21) Appl. No.: 14/353,030

(22) PCT Filed: Feb. 22, 2012
(86) PCT No.: PCT/CN2012/071456

§ 371 Date: Jun. 15, 2014

(51) Int. Cl. B41J 2/21

(52) U.S. Cl. CPC B41J 2/21
USPC 347/9

(57) ABSTRACT

The present invention provides an inkjet printing apparatus that includes at least one print head jetting coating inks, several print heads jetting color inks and a control system controlling print heads, wherein the print heads jetting coating inks and those jetting color inks are in three rows with print heads jetting color inks in the first and third row and those jetting coating inks in the second row, and print heads jetting the same color ink are the same in number. The control system controls all print heads in the three rows to jet inks at the same time to realize double-image printing. The inkjet printing apparatus in the present invention can realize pre-coat printing, post-coat printing, double-image printing and double-speed printing by controlling different rows of print heads to eject ink droplets. In the double-image printing mode, the two images can be the same or different. If the two images are the same, transparency of one of the images can be adjusted.

### FIELD OF THE INVENTION

The present invention relate generally to an inkjet printing apparatus, and more particularly to an inkjet printing apparatus for multi-printing modes and its printing method.

### BACKGROUND OF THE INVENTION

Inkjet printing is a technology that uses print heads to eject ink droplets on the media to form required images. Each kind of ink or ink mixtures jetted on the media will turn into a specific color, such as yellow, cyan, magenta, etc. To assure that the color of the image printed on the media is what is required, the media where the image is printed should be white or nearly white. Otherwise, the image color will be affected by the non-white media color and be different from what is needed.

In this case, in order to acquire the right color of the color image printed on a non-white media, such as colored media or transparent media, a layer of white ink should be printed on the media as the background. For example, if a color image is to be printed on a black media or color media, a layer of white ink should be printed first on the area where the color image will be printed, then print the color image on the white ink layer. The white background can prevent the image color from being affected by the color of the non-white media.

If the media is transparent, the color image should be printed first on the back side of the media and then print the white ink on the color image. When looking at the image from the front side of the transparent media, the white ink layer is called foreground color. With the white ink printed on the color image, the image color seen from the front side of the media will be the proper color required.

The drawback of adopting this printing technology to print color image on non-white media is that one more step to print the foreground color or background color should be added. Besides, the step added to print the white ink layer may be performed by another independent printing system, which increases both the printing cost and printing time. In other cases, print heads that are only used for white ink printing are installed in the inkjet printing system, as shown in FIG. 1 and FIG. 2 print heads jetting white ink are placed both in the front and at the back of the print heads jetting color inks. The disadvantage of this printing method is that the head plate depth and carriage width will be increased.

The patent application No. WO2006/078799 provides an inkjet printing apparatus and printing method shown in FIG. 3, where print heads aligning abreast are divided into two or three sections to print color inks or white ink. Due to low utilization rate of head nozzles, the printing speed is low.

The patent application No. US2005/0162451A1 provides an inkjet printing apparatus and printing method shown in FIG. 4, where print heads jetting different inks are in vertical arrangement which will increase head plate depth and carriage width.

When printing on flex banner with the conventional inkjet printing method, image of a single-layer has the appropriate color depth during day time. However, the color of the single-layer image will become lighter at night when exposed to the light. The measure taken by the printing method in prior art is that two layers are printed to increase the color depth of the image which may be appropriate at night but too dark during the day time.

### SUMMARY OF THE INVENTION

In view of the problems in prior art, the purpose of the present invention is to provide an inkjet printing apparatus and printing method.

To realize the above mentioned purpose, the inkjet printing apparatus in the present invention includes at least one print head jetting coating ink, several print heads jetting color inks and a control system controlling print heads, wherein all the print heads are in three rows with print heads jetting color inks in the first and the third row and print heads jetting coating inks in the second row. Print heads jetting the same color ink are the same in number. Along the direction of nozzle arrangement, the print heads in the first and the second row are installed with a space between them or they are interlaced end to end. Along the direction of nozzle arrangement the print heads in the second and the third row are installed with a space between them or they are interlaced end to end. The coating ink is white ink or Varnish.

All print heads jetting coating ink in the second row extrude white ink or Varnish, half of the print heads jetting coating inks in the second row extrude white ink and the other half extrude Varnish.

The inkjet printing method in the present invention, wherein the control system controls print heads jetting color inks in the first row to print image one on the media, print heads jetting coating ink in the second row to extrude a layer of coating ink on the image one and print heads jetting color inks in the third row to print image two on the coating ink. In this way, the double-image printing is achieved.

The image one and the image two are identical, and one of the image can be adjusted in terms of transparency.

The image one and the image two can be different images.

The inkjet printing method, wherein the control system controls print heads jetting color inks in the first row to print the image on the media, then print heads jetting coating inks extrude coating ink on the image while print heads jetting color inks in the third row not to extrude inks. In this way, pre-coat printing is achieved. In the pre-coat printing the media is transparent media, such as glass.

The inkjet printing method, wherein the control system control print heads jetting coating ink in the second row to print a layer of coating ink on the media, then print heads jetting color inks in the third row to print the image on the coating ink while print heads jetting color inks in the first row not to extrude inks. In this way, post-coat printing is achieved. In the post-coat printing the media is non-white media.

The inkjet printing method, wherein the control system controls print heads jetting color inks in the first row and those in the third row to print images on the media at the same time, while print heads jetting coating inks in the second not to extrude inks. In this way, the double-image printing is achieved.

The inkjet printing method, wherein the control system controls print heads jetting color inks in the first and the third row to print printing data of the same image to realize double-speed printing.

Compared to the printing method in prior art, the present invention has the following advantages:

1. Printing modes as pre-coat printing, post-coat printing, double-image printing can be realized by controlling print heads in different rows to extrude inks.

2. Double-image printing can print two identical or different images.

3. When the two images printed by the double-image printing are the same, the transparency of one image can be adjusted.

4. Double-speed printing is realized under the condition that coating inks are not jetted. Because print heads jetting color inks are installed in two rows, possibility of band occurrence is reduced.

### BRIEF DESCRIPTION OF THE DRAWINGS

FIG. 1 is a perspective view of one inkjet printing apparatus in prior art;

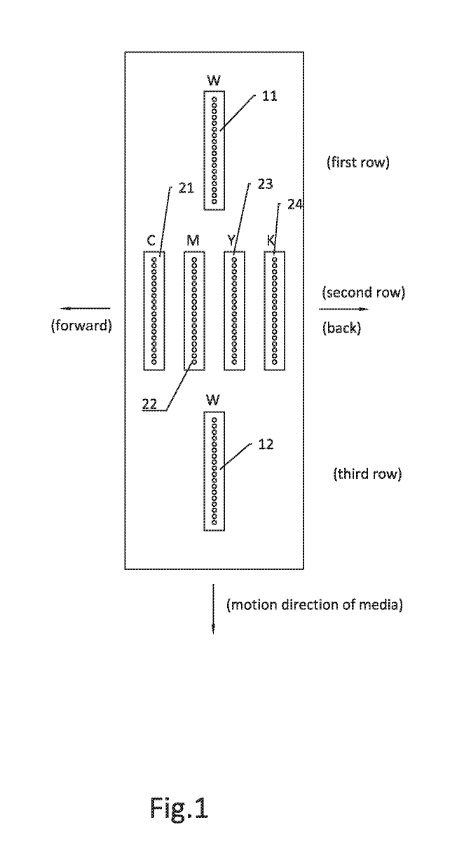

FIG. 2 is a schematic diagram of another inkjet printing apparatus in prior art;

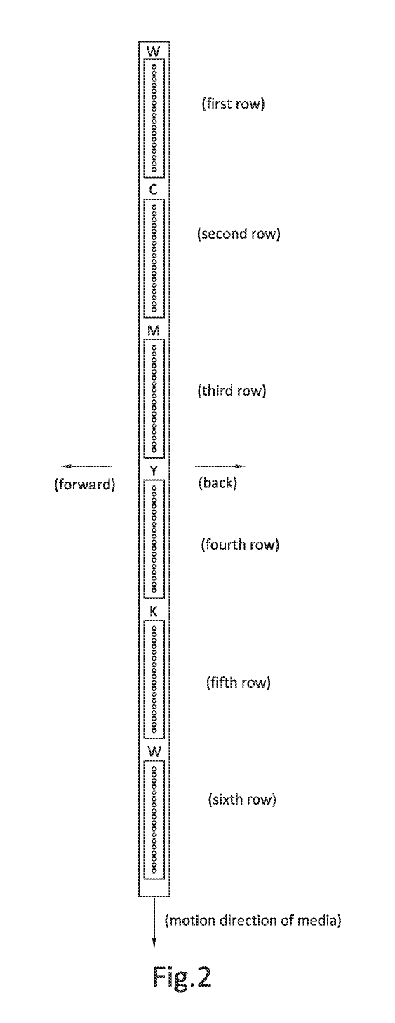

FIG. 3 is a schematic diagram of a third inkjet printing apparatus in prior art;

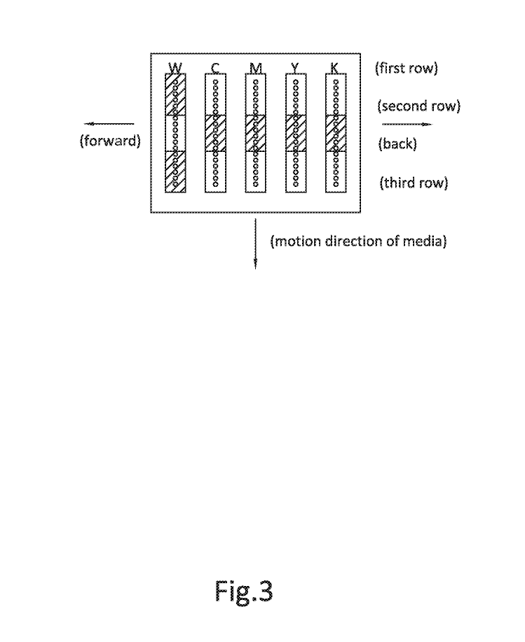

FIG. 4 is a schematic diagram of a fourth inkjet printing apparatus in prior art;

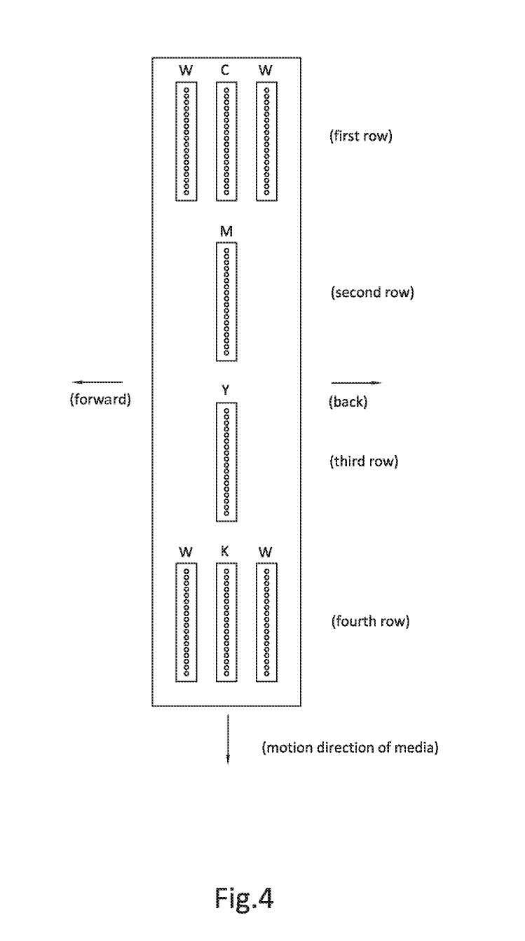

FIG. 5a is a schematic diagram of the inkjet printing apparatus in one embodiment in the present invention;

FIG. 5b is a schematic diagram of the inkjet printing apparatus in another embodiment in the present invention;

FIG. 6 is a flow chart of the inkjet printing method in the present invention;

FIG. 7 is a schematic diagram of pre-coat printing in the multi-channel printing mode;

FIG. 8 is a schematic diagram of post-coat printing in the multi-channel printing mode;

FIG. 9 is a schematic diagram of double-speed printing in the single-channel printing mode.

### DETAILED DESCRIPTION OF THE EMBODIMENT

Preferred embodiments of the inkjet printing apparatus and method according to the present invention are described below with reference to the accompanying figures.

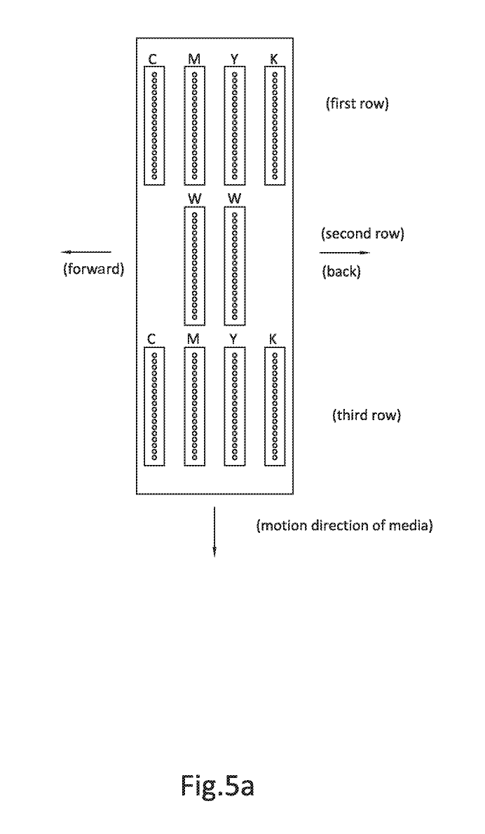

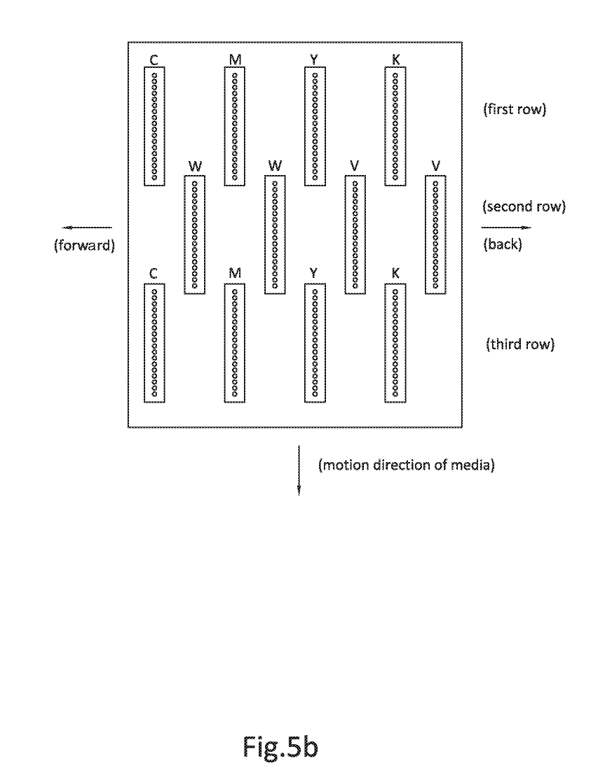

As shown in FIG. 5a, the inkjet printing apparatus in one embodiment in the present invention includes print heads of three rows and a control system. Print heads in the first and the third row jet color inks with two print heads used to jet one color ink; print heads in the second row jet coating inks. In the first row, four print heads c1, m1, y1 and k1 are installed to jet color inks; in the second row, two print heads w1 and w2 are installed to print coating inks; in the third row, four print heads c2, m2, y2 and k2 are installed to jet color inks. Along the direction of nozzle arrangement, print heads c1, m1, y1 and k1 in the first row and print heads w1 and w2 in the second row are installed with a space between them, so are print heads c2, m2, y2 and k2 in the third row and print heads w1 and w2 in the second row. Four printing modes: pre-coat printing, post-coat printing, double-image printing and double-speed printing can be realized with the control system controlling print heads in different rows to eject ink droplets. Coating inks used in the present invention can either be white ink or Varnish. Both of the print heads w1 and w2 can jet white ink or Varnish, or one print head w1 jets white ink and the other w2 jets Varnish. As shown in FIG. 5b, print heads c1, m1, y1 and k1 in the first row and print heads w1 and w2 in the second row can be installed interlaced end to end, so do print heads c2, m2, y2 and k2 in the third row and print heads w1 and w2 in the second row.

In pre-coat printing mode, print heads c1, m1, y1 and k1 jetting color inks in the first row and print head w1 and w2 jetting coating inks in the second row extrude inks while print heads c2, m2, y2 and k2 jetting color inks in the third row do not eject ink droplets.

In post-coat printing mode, print heads w1 and w2 jetting coating inks in the second row and print heads c2, m2, y2 and k2 jetting color inks in the third row extrude inks while print heads c1, m1, y1 and k1 jetting color inks in the first row do not eject ink droplets.

In the double-image printing mode, all print heads in the three rows: print heads c1, m1, y1 and k1 jetting color inks in the first row, print heads w1 and w2 jetting coating inks in the second row and print heads c2, m2, y2 and k2 jetting color inks in the third row, jet inks at the same time.

In the double-speed printing mode, print heads c1, m1, y1 and k1 jetting color inks in the first row and print heads c2, m2, y2 and k2 jetting color inks in the third row eject ink droplets while print heads w1 and w2 jetting coating inks in the second row do not eject ink droplets.

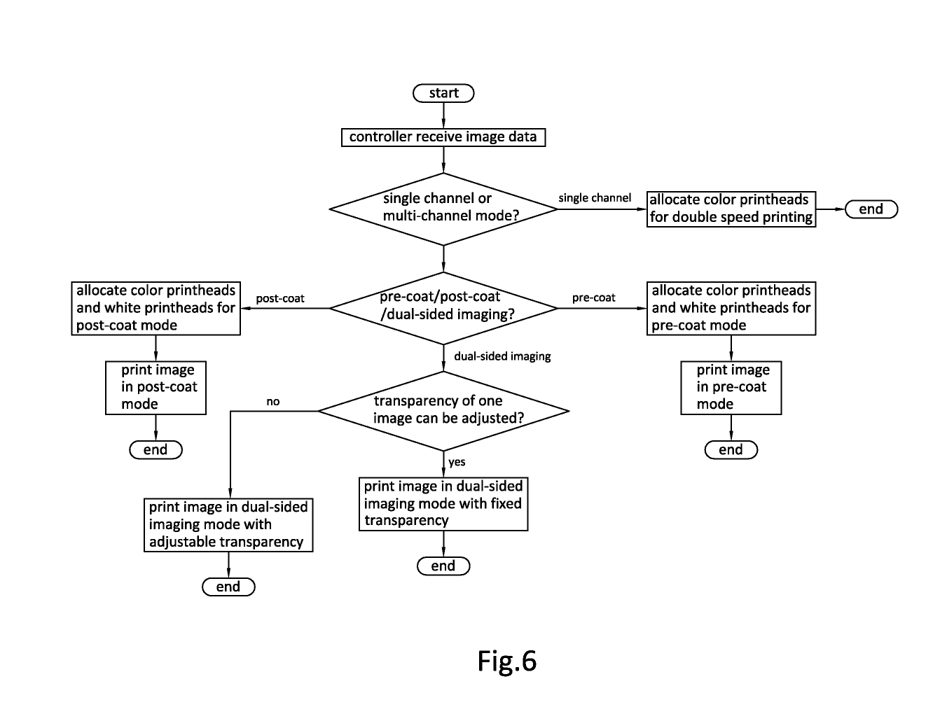

FIG. 6 is a flow chart of the inkjet printing method in the present invention. Before printing, the control system receives the printing data of the image and then the user chooses single-channel printing mode or multi-channel printing mode according to the printing requirement. If single-channel printing is selected, the control system controls print heads jetting color inks in the first and the third row to print the image. Because two print heads are used to print one color ink, the printing speed is twice times faster and so double-speed printing is realized. If multi-channel printing is selected, the pre-coat printing, post-coat printing and double-image printing can be realized by the user. In pre-coat printing, print heads jetting color inks in the first row and print heads jetting coating ink in the second row extrude inks while print heads jetting color inks in the third row do not extrude inks; In background printing, print heads jetting coating inks in the second row and print heads jetting color inks in the third row extrude inks while print heads jetting color inks in the first row do not extrude inks; In double-image printing, print heads jetting color inks in the first and the third row and print heads jetting coating inks in the second row extrude inks at the same time, among which print heads jetting color inks in the first row and those in the third row can print either the same or different printing data, and if the printing data printed are the same, then the transparency of one of the two images can be adjusted.

Preferred embodiments of different printing modes in the present invention are described below with reference to the accompanying figures.

### Embodiment One

The inkjet printing apparatus for double-image printing in the multi-channel printing mode is shown in FIG. 5a. The carriage moves to and fro in the direction perpendicular to the media movement and all print heads including printing heads jetting color inks in the first and the third row and those jetting coating inks in the second row extrude inks to print the image. During printing, the control system controls print heads c1, m1, y1 and k1 jetting color inks in the first row to print image one on the media, then print heads w1 and w2 jetting coating inks to eject the white ink on image one and at last, print heads c2, m2, y2 and k2 jetting color inks to print image two on the white ink layer. Image one and image two in the present invention can either be the same or different.

If the media is semi-transparent, such as the flex banner, image one and image two should be two identical images, among which image one can be adjusted in terms of transparency. Appropriate transparency can assure appropriate color depth of the image seen both during the day and at night.

If the media is transparent, such as glass, image one and image two can either be the same or different and the transparency of both of the images cannot be adjusted.

### Embodiment Two

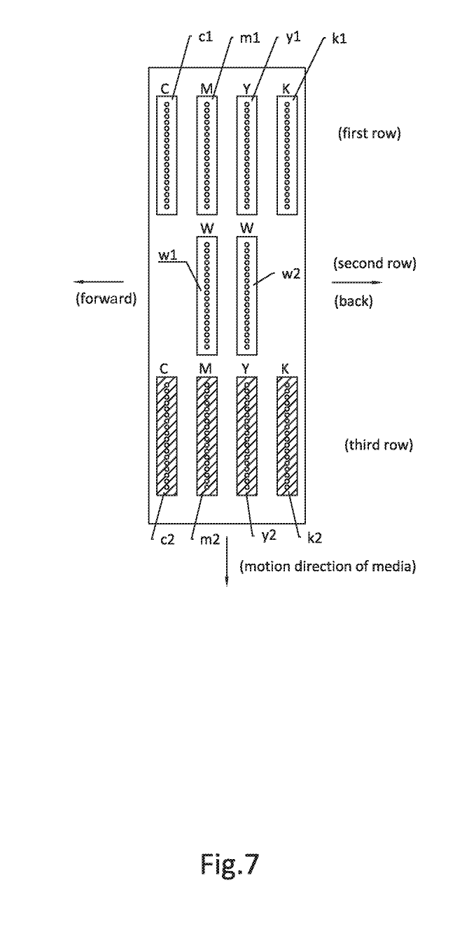

FIG. 7 is a schematic diagram of pre-coat printing in the multi-channel printing mode. The control system controls the carriage to move to and fro in the direction perpendicular to the media movement. Print heads jetting color inks in the first row and print heads jetting coating inks in the second row extrude inks to print while print heads jetting color inks in the third row do not print. With media moving in the direction shown in FIG. 7, the control system controls print heads c1, m1, y1 and k1 jetting color inks in the first row to print the image on the media, then print heads w1 and w2 jetting coating inks in the second row to extrude white ink on the image. Foreground printing is applied to transparent media, such as glass.

### Embodiment Three

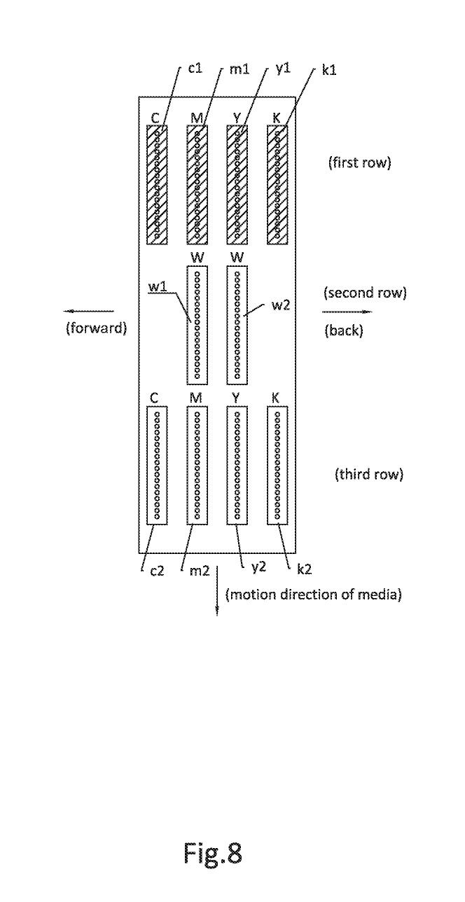

FIG. 8 is a schematic diagram of background printing in multi-channel printing mode. The carriage moves to and fro in the direction perpendicular to the media movement. Print heads jetting coating inks in the second row and print heads jetting color inks in the third row extrude inks to print the image while print heads jetting color inks in the first row do not print. During printing, the control system controls print heads w1 and w2 jetting coating ink in the second row to extrude coating ink on the media, then print heads c2, m2, y2 and k2 to print the image on the coating ink. Usually, background printing is applied to non-white media, on which a layer of white ink is printed to increase the color brightness. Coating inks in the present invention can be a color ink according to actual requirement.

### Embodiment Four

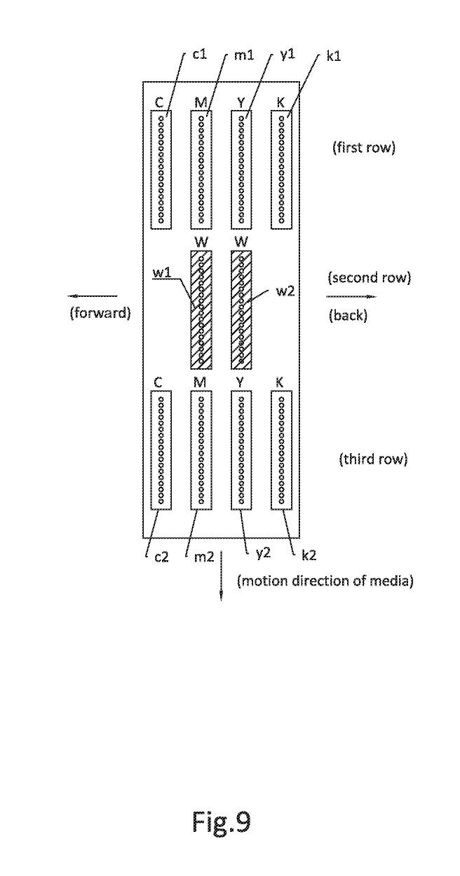

FIG. 9 is a schematic diagram of double-speed printing in the single-channel printing mode. The carriage moves to and fro in the direction perpendicular to the media movement. Print heads jetting color inks in the first and the third row extrude inks to print while print heads jetting coating inks do not print. In double-speed printing, the image printed is a single-layer one with no coating ink printed. During printing, the control system controls the inks to be extruded from print heads c1, m1, y1 and k1 jetting color inks in the first row and print heads c2, m2, y2 and k2 jetting color inks in the third row. Because one color ink is printed by two print heads, so the print speed is twice times faster than that of one print head printing.

More than one print heads jetting color inks or coating inks can be installed in series to increase printing speed.

It is to be understood that any alternations and modifications made to the detailed embodiment herein shall not depart from the scope of the claim and spirit of the present invention.

What is claimed is:

1. An inkjet printing apparatus includes:
a) At least one print head jetting coating inks;
b) Several print heads jetting color inks;
c) A control system controlling print heads;
Wherein print heads jetting coating inks and those jetting color inks are in three rows with print heads jetting color inks in the first and the third row and those jetting coating inks in the second row.

2. The inkjet printing apparatus of claim 1, wherein print heads jetting the same color ink are the same in number.

3. The inkjet printing apparatus of claim 1, wherein along the direction of nozzle arrangement the print heads in the first row and those in the second row are installed with a space between them.

4. The inkjet printing apparatus of claim 1, wherein along the direction of nozzle arrangement, the print heads in the second row and those in the third row are interlaced end to end.

5. The inkjet printing apparatus of claim 1, wherein the coating ink is white ink.

6. The inkjet printing apparatus of claim 1, wherein the coating ink is Varnish.

7. The inkjet printing method of claim 1, wherein the control system controls the print heads jetting color inks in the first row to print image one on the media, print heads jetting coating inks in the second row to eject the coating inks on image one and print heads jetting color inks in the third row to print image two on the coating ink; in this way, double-image printing is achieved.

8. The inkjet printing method of claim 7, wherein the image one and the image two are identical.

9. The inkjet printing method of claim 8, wherein the image one can be adjusted in terms of transparency.

10. The inkjet printing method of claim 7, wherein the image one and the image two are different.

11. The inkjet printing method of claim 7, wherein the coating ink is white ink.

12. The inkjet printing method of claim 1, wherein the control system controls print heads jetting color inks in the first row to print the image on the media, print heads jetting coating ink in the second row to eject coating ink on the image while print heads jetting color inks in the third row not to eject inks to achieve pre-coat printing.

13. The inkjet printing method of claim 12, wherein the media is transparent, such as glass.

14. The inkjet printing method of claim 1, wherein the control system controls print heads jetting coating ink in the second row to eject coating ink on the media, print heads jetting color inks in the third row to print the image on the coating ink while print heads jetting color inks in the first row not to eject inks to achieve post-coat printing.

15. The inkjet printing method of claim 14, wherein the media is non-white.

16. The inkjet printing method of claim 14, wherein the coating ink is white ink.

17. The inkjet printing method of claim 1, wherein the control system controls print heads jetting color inks in the first and the third row to print images on the media at the same time to achieve double-image printing, the print heads jetting coating inks in the second do not eject inks.

18. The inkjet printing method of claim 17, wherein the control system controls print heads jetting color inks in the first and the third row to print the printing data of the same image to achieve double-speed printing.
